(19) United States
(12) Patent Application Publication
(10) Pub. No.: US 2024/0236164 A9
(43) Pub. Date: Jul. 11, 2024

(54) ASYNCHRONOUS VIDEO TRANSPORT

(71) Applicant: MaxLinear, Inc., Carlsbad, CA (US)

(72) Inventors: Hang Jin, Irvine, CA (US); Pinaki Shankar Chanda, San Diego, CA (US); Michael D. Jarchi, Mission Viejo, CA (US)

(73) Assignee: MaxLinear, Inc., Carlsbad, CA (US)

(21) Appl. No.: 18/493,726

(22) Filed: Oct. 24, 2023

Related U.S. Application Data
(60) Provisional application No. 63/380,724, filed on Oct. 24, 2022.

(51) Int. Cl. H04L 65/611; H04L 65/70

(52) U.S. Cl. CPC H04L 65/611; H04L 65/70

(57) ABSTRACT

A method includes a method includes obtaining source data from a data source, the source data may correspond to a source clock and may be stored in a data buffer. The method may also include performing a clock adjustment to a determined clock. The determined clock may be associated with a data stream output from the data buffer. The clock adjustment may be operable to equalize the source clock and the determined clock. The method may include identifying a symbol clock associated with a buffer device. The method may also include adjusting an amount of null packets in the data stream, in response to a number of elements in the buffer device satisfying a threshold amount in the buffer device. The method may include updating clock reference values present in the source data such that a client device may synchronize with the source data with minimal clock jitter.

### CROSS REFERENCE TO RELATED APPLICATIONS

This U.S. Patent Application claims priority to U.S. Provisional Patent Application No. 63/380,724, titled “ASYNCHRONOUS VIDEO TRANSPORT,” and filed on Oct. 24, 2022, the disclosure of which is hereby incorporated by reference in its entirety.

### TECHNICAL FIELD

This disclosure generally relates to a distributed architecture having a remote device, and more specifically, to asynchronous audio/video transport using a remote device.

### BACKGROUND

Unless otherwise indicated herein, the materials described herein are not prior art to the claims in the present application and are not admitted to be prior art by inclusion in this section.

A remote device may be included in a system for transporting data within the system, such as between a data source and a client device. The remote device may be a Remote Physical layer (PHY) Device (RPD) and/or a Remote Medium Access Control layer (MAC) PHY device (RMD). The remote device may be included in a network having a distributed access architecture (DAA) such as in a HFC (Hybrid Fiber Cable) network and may be used in the transmission of data between the data source and the client device, where the data may be digital audio, video, or a combination thereof. The transmission of the data may use MPEG transport stream format as typically used in video broadcast networks.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method includes obtaining source data from a data source, the source data may correspond to a source clock and may be stored in a data buffer. The method may also include performing a clock adjustment to a determined clock. The determined clock may be associated with a data stream output from the data buffer. The clock adjustment may be operable to equalize the source clock and the determined clock. The method may include identifying a symbol clock associated with a buffer device. The method may also include adjusting an amount of null packets in the data stream, in response to a number of elements in the buffer device satisfying a threshold amount in the buffer device, e.g., a buffer device getting filled up or depleted beyond one or more than one threshold. The method may also include adjustment of clock reference in the data stream as it is sent to a downstream client device so that client device can synchronize with incoming data stream with minimal jitter.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example system for asynchronous data transport;

FIG. 2 illustrates an example system for asynchronous data transport;

FIG. 3 illustrates a flowchart of an example method of asynchronous data transport; and

FIG. 4 illustrates a diagrammatic representation of a machine in the example form of a computing device implementing asynchronous data transport.

### DETAILED DESCRIPTION

A remote device, such as a remote PHY device (RPD), may be operable to support asynchronous video. In such instances, a source clock associated with a data source may differ from an internal clock associated with a remote device, which may differ from a device clock associated with a receiving device, such as a set-top box. The remote device may be constrained to manage a clock rate difference between the source clock and the internal clock as the source data is obtained from the source device, and the remote device may be operable to output a data stream at a rate (according to the internal clock) that may be obtained by the receiving device. The receiving device (or the client device) may synchronize to the data stream using clock references that are generated by the source device and updated by the remote device when necessary, particularly to account for rate adjustments between source device and remote device. The synchronization may be done in such a way that may introduce a minimal jitter in a clock synchronization process in the receiving/client device.

Managing the clock rate difference between the source clock and the internal clock may be approached by inserting and/or deleting null packets in the data stream which may result in clock discrepancies with the device clock (e.g., as the data stream may be altered from the internal clock due to the null packets inserted/deleted from the data stream). Some prior approaches may perform a program clock reference (PCR) correction directed to handling the clock discrepancies, but may cause a transport stream packet underflow or overflow in the client device, which may result in lost data packets, and/or interruptions to a service associated with the data stream. The prior approaches may also cause excessive jitter in the clock synthesized by the client device.

Some aspects of the present disclosure may be directed to equalizing an internal clock with a source clock by monitoring a rate at which source data is obtained by a data buffer in the remote device, and subsequently transmitted out of the data buffer in the remote device. Further, the remote device may include a buffer device that may be operable to insert and/or drop null packets in a data stream (e.g., the source data transmitted out of the data buffer), such that the rate of data of the data from the buffer device transferred using the equalized internal clock matches with the rate of data transfer using a symbol clock driving the next block e.g. a modulator. The symbol clock may be associated with a rate at which the data stream is read into the buffer device and the internal clock may be associated with a rate at which the data stream is written out of the buffer device.

Further aspects of the present disclosure may include novel approaches to correcting clock reference values that may be affected by inserting and/or dropping null packets from the data stream. For example, a delta clock reference value may be determined using characteristics of the null packets in the data stream and the delta clock reference value may be used to correct any issues that may be introduced by inserting and/or dropping null packets. In another example, a frequency offset estimation, measured in part per million, may be determined in view of a number of elements in the buffer device and characteristics of the null packets in the data stream, considered over a period of time. Alternatively, or additionally, techniques described herein may distribute the corrections to the clock reference values over one or more data packets in the data stream, such that there may not be a clock reference value overflow or underflow and/or the device clock may be able to lock and/or remain locked to the internal clock of the remote device.

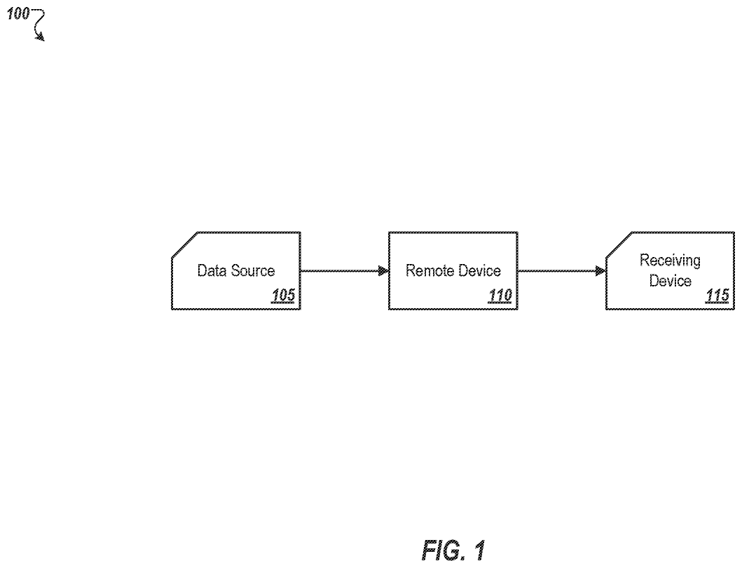

FIG. 1 illustrates an example system 100 for asynchronous data transport, in accordance with at least one embodiment of the present disclosure. The system 100 may include a remote device 110. The remote device 110 may be termed remote as operations performed by

the remote device 110 may be distributed (e.g., remotely) from a data source 105 which may have been previously performed by the data source 105. In some embodiments, the remote device 110 may be remote physical layer (PHY) device (RPD). Alternatively, or additionally, the remote device 110 may be a remote medium access control layer (MAC) PHY device (RMD). The data source be a video core, a converged cable access platform (CCAP) core, and/or a video core integrated with a CCAP core, used in distributed access architecture (DAA) in HFC network.

The remote device 110 may obtain source data from the data source 105. The data source 105 may be a video server, a video network, and/or any other system or device that may generate and/or transmit the source data to the remote device 110. The source data may include video data, digital audio data, and/or a combination of video data and digital audio data. For example, the source data may be moving picture experts group (MPEG) transport stream data (MPEG-1) and/or may conform to at least one of the standards for the elementary streams that are part of the transport stream data (e.g., MPEG-2, MPEG-4, Dolby Atmos, H.264, HEVC, AV1, VVC, Windows Media, DTS etc.).

The data source 105 may be operable to transfer the source data to the remote device 110 at a data rate that may be associated with a source clock included in the data source 105. For example, in instances in which the source clock is faster than a default clock, an associated data rate may be higher than a default data rate associated with the default clock (e.g., the source data may be transmitted to the remote device 110 faster). In another example, in instances in which the source clock is slower than the default clock, an associated data rate may be lower than the default data rate associated with the default clock. There may be clock references in the source data from the data source 105 for a receiving device 115 (to which the remote device 110 may be connected) to and the clock references may be generated by the source device 105 using the source clock.

In general, the source clock may be defined to be within a predefined clock value, but specifics of the source clock may vary. For example, the source clock of the data source 105 may have a first frequency and/or a first phase associated therewith, and a second source clock of a second data source (not illustrated) may have a second frequency and/or a second phase associated therewith. In the examples, both the source clock and the second source clock may be within a predefined clock value, but may include deviations within an acceptable and/or predetermined threshold, such as defined by a standard (e.g., such as the MPEG-4 standard).

The remote device 110 may include one or more clocks that may be used as part of obtaining the source data from the data source 105 and transmitting the source data (or a variation of the source data, as described herein) to a receiving device 115. The remote device 110 may include at least a first clock that may be operable to match, or substantially match the source clock. In some embodiments, the frequency of the source clock may differ from the frequency of the first clock and/or the source clock and the first clock may experience different rates of drift. For example, in instances in which the source clock and the first clock have a substantially similar frequency at a particular time, the source clock may drift relative to the first clock, such that at a second time, the frequency of the source clock and the frequency of the first clock may differ.

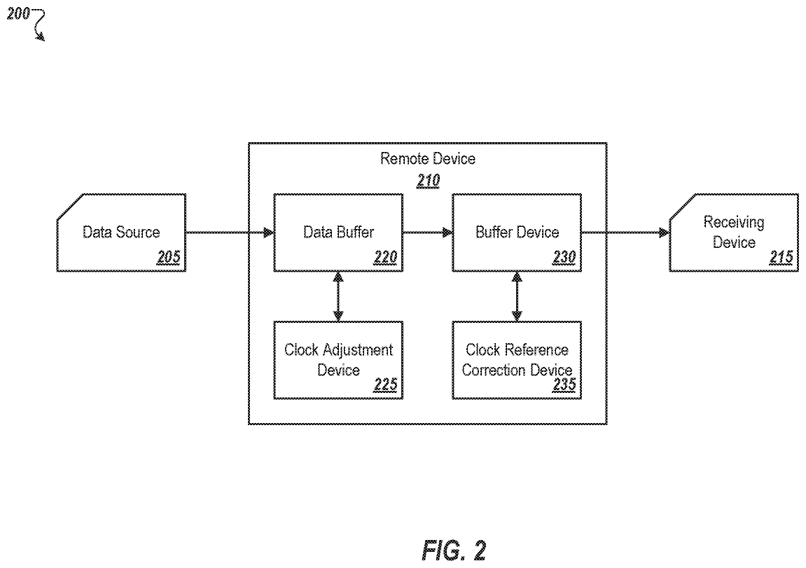

In some embodiments, the remote device 110 may not have characteristics of the source clock (e.g., such as a frequency and/or a phase). Alternatively, or additionally, the remote device 110 may know that the characteristics of the source clock may be limited to values defined by the standard. Thus, the remote device 110 may employ one or more techniques (as described herein, such as relative to FIG. 2) to determine the source clock (e.g., the frequency and/or phase), such that a determined clock (e.g., which may be the same as the first clock of the remote device 110 described herein) may be the same or similar as the source clock.

The remote device 110 may be operable to obtain the source data from the data source 105, reduce and/or remove jitter that may be associated with the source data, and transmit a data stream to a receiving device 115. The receiving device 115 may be a set-top box, and/or any other consumer device that may utilize the source data. In some embodiments, the receiving device 115 have experience difficulty and/or may be unable to obtain the data stream (and/or packets included in the data stream) when an amount of jitter in the data stream may satisfy a threshold. For example, in instances in which an amount of jitter in the data stream from the remote device 110 exceeds a threshold amount of jitter, one or more data packets of the data stream may not be received and/or may not be recovered by the receiving device 115, such that the receiving device 115 may experience a degraded service, an interruption of service, and/or other issues related to a loss of data. The jitter may be due to burstiness of the input data as obtained by the remote device 110 from the data source 105, or it could be due to insertion or deletion of the null packets in the data stream that are used to adapt the input rate with the rate of the symbol clock of remote device.

As described herein, the remote device 110 may be operable to reduce and/or remove jitter from the data stream. The remote device 110 may include one or more components that may be operable to insert and/or drop null packets within the data stream, which may reduce and/or remove jitter from the data stream. Alternatively, or additionally, the remote device 110 may be operable to distribute effects that may be associated with inserting and/or dropping null packets across portions of the data stream, which may contribute to reducing and/or removing jitter from the data stream. In general, the remote device 110 may manage the data stream such that a clock in the receiving device 115 may lock and/or remain locked to a clock in the remote device 110 associated with the data stream, which may contribute to the receiving device 115 obtaining the data stream from the remote device 110.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

FIG. 2 illustrates an example system 200 for asynchronous data transport, in accordance with at least one embodiment of the present disclosure. The system 200 may include a remote device 210. The remote device 210 may include a data buffer 220, a clock adjustment device 225, a buffer device 230, and a clock reference correction device 235.

Some components of the system 200 may be the same or similar as components included in the system 100 of FIG. 1, and/or may be operable to perform the same or similar operations, unless described otherwise. For example, a data source 205, the remote device 210, and a receiving device 215 may be the same or similar as the data source 105, the remote device 110, and the receiving device 115 of FIG. 1, respectively.

The data buffer 220 may obtain source data from the data source 205 and may store the source data therein. The data buffer 220 may be configured to store up to a fixed amount of the source data (e.g., the data buffer 220 may have a maximum amount of data storage). In some embodiments, the data buffer 220 may be monitored and/or interacted with by a another device, such as the clock adjustment device 225 to determine an amount of source data stored in the data buffer 220 relative to a buffer data threshold amount. The buffer data threshold amount may be a predetermined amount of the data buffer 220, such as half of the maximum amount of data storage in the data buffer 220. Alternatively, or additionally, the buffer data threshold amount may be configurable, such as based on characteristics of the system 200, the data source 205, and/or the remote device 210, and/or in response to a user input.

In instances in which the amount of source data in the data buffer 220 satisfies the buffer data threshold amount, the clock adjustment device 225 may begin performing operations relative to a determined clock. The determined clock may be a clock associated with the remote device 210 that may be designed to match or substantially match a source clock of the data source 205 associated with the source data. Alternatively, or additionally, the determined clock may be associated with a data stream that may be output from the data buffer 220, such as to the buffer device 230. The clock adjustment device 225 may be a numerically controlled oscillator (NCO) loop filter. Alternatively, or additionally, the clock adjustment device 225 may be other systems or devices (including hardware, software, firmware, and/or combinations thereof) operable to perform the operations described herein.

The determined clock may be constrained by the specification associated with the source data and/or by other components included in the remote device 210 and/or the receiving device 215. For example, in instances in which the source data is MPEG-1 transport stream a frequency range of the determined clock may include a frequency requirement of ±30 parts per million (ppm) and a frequency drift of the determined clock may include a drift requirement of 0.075 Hz/s (approximately 10 ppm/hour).

The determined clock may begin at a nominal rate, such as any rate within a limitation defined by a specification associated with the source data. For example, in instances in which the source data is MPEG-1, MPEG-2, or MPEG-4, the nominal rate associated with the determined clock may be a rate defined in the MPEG-1, MPEG-2, or MPEG-4 specification. Once the source data in the data buffer 220 satisfies the buffer data threshold amount, the determined clock may begin (at the nominal rate), and the clock adjustment device 225 may perform one or more operations to adjust the determined clock to be the same or substantially the same as the source clock. For example, the clock adjustment device 225 may determine a rate at which the source data is obtained in the data buffer 220 and may make adjustments to the determined clock such that the data stream make exit the data buffer 220 at substantially the same rate. The clock adjustment device 225 may be operable to equalize and/or substantially equalize the determined clock to the source clock. The clock adjustment device 225 may establish a dynamic equilibrium equalized with the source clock so that the frequency offset between the determined clock and the source clock is nullified with very little frequency jitter.

In some embodiments, the source data may include variations like jitter, which may be attributed to burstiness of the traffic in the network between the data source 205 and the remote device 210, and/or due to lost packets during transmission from the source device 205 to the remote device 210 and/or burst transmissions. The clock adjustment device 225 may be operable to obtain measurements associated with the source data in the data buffer 220 (e.g., a source data rate, and/or take an average of the measurements. In some embodiments, the measurements may be obtained at a preconfigured interval. For example, the clock adjustment device 225 may include an Infinite Impulse Response (IIR) filter, a Finite Impulse Response (FIR) filter, and/or may be an adaptive filter that may perform an averaging of the measurements, based on the preconfigured interval. A change slope relative to the source data in the data buffer 220 may be computed using:

ppm=(buff_level₁−buff_level₀)/(t₁−t₀)

where buff_level₁ and buff_level₀ describe the amount of source data in the data buffer 220 at a second time t₁ and a first time t₀, respectively. Further, buff_level₁ and buff_level₀ may be obtained from the IIR filtering of the source data in the data buffer 220 and/or the times t₁ and t₀ may be with respect to the determined clock.

In some embodiments, the above equation related to the change slope of the source data in the data buffer 220 may include one or more outliers (which may be associated with dropped source data), which may skew the ppm calculation. The clock adjustment device 225 may be operable to remove the outliers. Alternatively, or additionally, the clock adjustment device 225 may be operable to average the calculated ppm values over a number of ppm data points, and use the averaged ppm values to refine the determined clock (such that the determined clock is equalized or substantially equalized to the source clock). The averaged ppm values may be adjusted by:

n_ppm=ceil(scale*n_ppm₀)

where n_ppm₀ is an initial number of average ppm values, n_ppm is an actual number of average ppm values, and scale is a scaling factor that may be calculated based on a change slope associated with the ppm values.

The clock adjustment device 225 may be operable to determine a frequency offset and/or a phase offset for the determined clock, such as by using the ppm values as described above. The frequency offset may be determined using an average of the ppm values over a preconfigured interval of time and may be represented by:

$$ppm\_avg = \frac{1}{n\_ppm} {\sum }_{i = 1}^{n \_ ppm} ppm ( i )$$

The phase offset may include an average of the source data in the data buffer 220 over a preconfigured interval of time, and may be represented by:

$$buff\_avg = \frac{1}{n\_ppm} {\sum }_{i = 1}^{n \_ ppm} buff\_sample ( i )$$

The averaged amount of source data in the data buffer 220 (buff_avg, or buffer average) may be compared to a target amount of source data in the data buffer 220 (buffer target), and in instances in which the buffer average is not equal to the buffer target, adjustments may be made by the clock adjustment device 225 to equalize the buffer average and the buffer target. Such adjustments may contribute to the determined clock becoming equalized to the source clock. An equation associated with the adjustments to the determined clock may be:

freq_adj=freq_adj*(1+beta*ppm_avg+phase_coef*buff_avg)

where freq_adj is the adjusted frequency associated with the determined clock, beta is a damping factor (e.g., a value less than one), ppm_avg is the average ppm values (determined above), phase_coef is a scaling factor associated with a phase adjustment (e.g., may default to 1 ppm, or 1.0e-6), and buff_avg is the phase adjustment (determined above). In such instances, the computed adjusted frequency may be utilized by the clock adjustment device 225 to update the determined clock. In some embodiments, the computation of the adjusted frequency may be performed in firmware and may be transmitted for implementation in hardware.

The buffer device 230 may include a symbol clock that may differ from the determined clock and/or the source clock. For example, the symbol clock may be associated with a quadrature amplitude modulation (QAM) modulator symbol clock associated with the buffer device 230. The buffer device 230 may utilize the symbol clock to read in the data stream (e.g., one or more packets included in the data stream obtained from the data buffer 220) and the buffer device 230 may utilize the determined clock to write the data stream, such as directed to the receiving device 215.

In some embodiments, the symbol clock may differ from the determined clock such that a number of elements from the data stream within the buffer device 230 may experience drift over time. The buffer device 230 may be designed to attempt to maintain a threshold number of elements from the data stream therein. For example, the buffer device 230 may include space for a maximum number of elements (e.g., 256 bytes, or slightly larger than an MPEG-1 transport stream packet size, e.g., 188 bytes), and the buffer device 230 may begin performing operations when the number of elements in the buffer device 230 satisfies a threshold number of elements (e.g., approximately 94 bytes, or half of an MPEG-1 transport stream packet).

While the buffer device 230 is performing operations, in instances in which the symbol clock is faster than the determined clock, the number of elements in the buffer device 230 may increase (e.g., the amount of the data stream being read into the buffer device 230 is greater than the amount of the data stream being written out of the buffer device 230). Alternatively, or additionally, in instances in which the symbol clock is slower than the determined clock, the number of elements in the buffer device 230 may decrease (e.g., the amount of the data stream being read into the buffer device 230 is less than the amount of the data stream being written out of the buffer device 230).

The buffer device 230 may be operable to adjust an amount of null packets in the data stream. Adjusting the amount of null packets in the data stream may contribute to reducing and/or eliminating the drift in the data stream associated with the difference between the symbol clock and the determined clock. In some embodiments, the buffer device 230 may determine when to adjust the amount of null packets in the data stream. Alternatively, or additionally, control logic hardware and/or control logic software may be included in the remote device 210 and may be operable to adjust the amount of null packets in the data stream.

In instances in which the number of elements in the buffer device 230 satisfy an upper threshold in the buffer device 230, one or more null packets may be dropped from the data stream. For example, the upper threshold may be 230 elements or more, and in instances in which the number of elements in the buffer device 230 is greater than 230 elements, one or more null packets may be dropped from the data stream.

In instances in which the number of elements in the buffer device 230 satisfy a lower threshold in the buffer device 230, one or more null packets may be inserted into the data stream. For example, the lower threshold may be 20 elements or less, and in instances in which the number of elements in the buffer device 230 is less than 20 elements, one or more null packets may be inserted into the data stream. The buffer device 230 may continue inserting and/or dropping null packets in the data stream such that the number of elements in the buffer device 230 may be maintained between the upper threshold and the lower threshold. Alternatively, or additionally, a hysteresis loop may be used when a packet insertion or a packet deletion is performed. The packet insertion may begin when the lower threshold is satisfied, and the packet insertion may continue until the buffer level is built up to a pre-determined offset above the lower threshold. Similarly, packet deletion may start when the higher threshold is satisfied, and the packet deletion may continue until the buffer level is built up to a pre-determined offset below the higher threshold.

In some embodiments, the adjustments to the amount of null packets in the data stream may cause one or more clock reference values (e.g., program clock reference (PCR) values) in the data stream to be shifted in time. For example, in the original data stream between two clock reference values, there may be ‘n’ transport stream packets but there can be one or more null packets inserted, making the effective distance in time between the two clock reference values different from ‘n’ transport stream packets. As such, a large phase offset may be built in a positive and/or a negative direction with each insertion and/or deletion of null packets, and that the phase offset may be dissipated in time. Shifted clock reference values, and therefore, the large phase jitter, may affect how a clock associated with the receiving device 215 is able to lock with the determined clock. In some instances, sudden corrections to the clock reference values may cause issues with the receiving device 215 is able to lock with the determined clock. The clock reference correction device 235 may be operable to perform a correction to the clock reference values, and/or may be operable to distribute the correction to the clock reference values over multiple packets, which may reduce the suddenness of the correction and may contribute the clock included in the receiving device 215 remaining locked with the determined clock.

The corrections to the clock reference values by the clock reference correction device 235 due to the adjustments to the amount of null packets in the data stream (e.g., inserting null packets and/or dropping null packets) may comply with an accuracy requirement defined in a specification, such as ITU-T Rec. H.222.0. For example, a clock reference value tolerance may be ±500 ns, where time shifts caused by adjustments to the amount of null packets in the data stream may exceed the clock reference tolerance.

In a first implementation, the adjustments to the amount of null packets in the data stream may be corrected by determining a delta clock reference value based on whether a null packet is inserted or dropped. The generalized equation is:

t_c0_{PRIOR}=0

t_c=+/−t_c0_{PRIOR}+/−[t_d*(1−t_dis/t_i)]

t_c0_{NEXT}=(t_i−t_dis)/t_i*t_d
where t_c0_{NEXT} is the remainder value of the t_c correction value at the NULL event
   and where:
t_d: APCR
   duration in time for one MPEG packet; is based upon baud rate, QAM modulation order, line encoding
   sign based upon null event being an insert or delete
t_i: number of packets between rate adaptation null events
   reflects the frequency delta between the source data clock and the determined clock
t_dis: MPEG PCR position
   Number of packets from the null event to MPEG PCR packet
t_c: PCR Correction value
   this is a correction computation made given the distance of the MPEG PCR packet from the prior null event, as related to t_d and t_i.
t_c0: PCR Correction carry
   As noted, t_i will change/drift with time. When a NULL event occurs, either before or after the expected t_i, the t_c has a remainder (or overrun) value that needs to be carried on to the next t_c correction cycle. The t_c0 component exposes an error in t_d and/or t_i.

In instances in which a null packet is inserted, the delta clock reference value may be determined using:

t_c_{INSERT}=+/−t_c0_{PRIOR-INSERT}+[t_d*(1−t_dis_{INSERT}/t_i_{INSERT})]

t_c0_{NEXT-INSERT}=(t_i_{INSERT}−t_dis_{INSERT})/t_i_{INSERT}*t_d(at NULL event)

In instances in which a null packet is dropped, the delta value may be determined using:

t_c_{DELETE}=+/−t_c0_{PRIOR-DELETE}−[t_d*(1−t_dis_{DELETE}/t_i_{DELETE})]

t_c0_{NEXT-DELETE}=(t_i_{DELETE}−t_dis_{DELETE})/t_i_{DELETE}*t_d(at NULL event)

The total of these two equations are summed:

t_c=t_c_{INSERT}+t_c_{DELETE}

Conventional techniques may determine the delta clock reference value using t_c→+/−m*t_d; where m is the total number of the null packets inserted/deleted (accumulative), which may result in underflow/overflow of the transport stream packets in the receiving device 215 when the receiving device 215 compares the presentation time stamp of the audio or video elementary stream packets with the local clock generated following updated program clock reference values updated in the remote device 210 by simply adjusting the program clock reference values by time corresponding to aggregated number of null packets inserted or deleted. The present disclosure addresses these and other shortcomings of the conventional techniques by calculating the delta clock reference value using t_c→t_c+/−a*t_d; where a<2. Further, the delta clock reference value may be bounded by ˜2*t_d. Alternatively, or additionally, the average time interval (e.g., t_i) may be updated with a moving average for the calculations described herein.

In a second implementation, the number of elements in the buffer device 230 may be observed according to a number of time points t(i), i=1, 2, 3, . . . , where the time points may have a fixed time interval (e.g., t(i+1)−t(i)=t_i). In some embodiments, t_i may be constant and/or configurable, such as via software. A determination as to the adjustments to the amount of null packets in the data stream may be determined by the following:

ppm0=(B2−B1−t_del)/188*t_d/t_i

ppm=α*ppm0+(1−α)*ppm0(as an average)

where B1 and B2 are the number of elements in the buffer device 230 observed at t(i) and t(i+1), respectively; t_del is equal to (n−m)*188, where n is the total number of null packets inserted between t(i) and t(i+1) and m is the total number of null packet dropped between t(i) and t(i+1); t_d is the null packet duration; and α is a forgetting factor, as an average.

In some embodiments, the above implementation may be performed using hardware. In such instances, a value (av_timed_rate_fifo_lvl_count_cnfg) may be a measure of the number of packets to measure between, the number of elements in the remote device (e.g., at a start time (av_timed_rate_fifo_lvl_start) and an end time (av_timed_rate_fifo_lvl_end)) may be measured, and/or a number of null insertions and/or deletions may be obtained.

PPM=((av_timed_rate_fifo_lvl_end−av_timed_rate_fifo_lvl_start)+/−188*null counts)/(av_timed_rate_fifo_lvl_count_cnfg*188)

In another embodiment, ppm could be tracked based between null insertion/deletion events and monitoring number of elements in the remote device:

PPM=((av_rate_fifo_lvl_end−av_rate_fifo_lvl_start)+188)/(av_rate_fifo_delta_num_pkt*188)

Another embodiment may count number of bytes pushed into the remote device at the ingress rate, and a count of the number of bytes read at the egress rate over a specific duration of time.

PPM=(mpt_rate_fifo_bytes_out−mpt_rate_fifo_bytes_in)/mpt_rate_fifo_bytes_out

In general, ppm may be measured by monitoring data in terms of course units like packets to other units, such as discrete as bits. The monitoring of the data combined with a measurement duration and/or other information, such as an addition/removal of data, may yield the ppm rate difference between ingress and egress.

In the above equations, ppm may not be defined as conventional frequency offset in units of ppm (parts per million), but rather may refer to a 1:1 slope (or part per one). In instances in which the ppm value is greater than zero, it may be determined that a null packet may be dropped from the data stream. Alternatively, or additionally, in instances in which the ppm value is less than zero, it may be determined that a null packet may be inserted into the data stream.

In some embodiments, the correction to the clock reference values may be associated with the null packet insertion/deletion events. The correction to the clock reference values may be rewritten in view of changes due to ppm updates, using:

$${t}_{c} = const + {t}_{c 0} + {t}_{d e l 0} + {\sum }_{i = 1}^{N} t\_dis ( i ) * ppm ( i )$$

where t_c is the delta clock reference value, const is a constant (e.g., const=−t_d) to ensure the clock reference value is less than the presentation time stamp, t_c0 is an uncompensated time shift that may be caused by a previous null packet insertion/deletion, t_del0 is equal to t_d if a null packet is inserted and t_del0 is equal to −t_d if a null packet is dropped, t_dis(i) is the distance in the ith observation intervals, and ppm(i) is the ppm used in the ith observation intervals (e.g., from the equations above), i=1, 2, . . . N. In some embodiments, t_c0 may be the t_c determined as a residue of the clock reference value correction from a previous null packet insertion/deletion at a time when the current null packet is inserted/dropped.

In either of the first implementation or the second implementation described above, the corrections to the clock reference values in one or more individual packets in the data stream may be distributed between the null packet events (e.g., the insertions or deletions of the null packets from the data stream). The distribution of the corrections may reduce jitter that may be introduced by the insertions/deletions of the null packets in the data stream, which may cause the clock in the receiving device 215 to no longer lock with the determined clock in the remote device 210.

For example, the data stream may include clock reference values associated with individual data packets therein, which may be distributed on a known interval. For example, a clock reference value may be included in data packets that are transmitted every 200 clock cycles. Using the equations described herein, it may be determined that a null packet may be inserted/dropped about every fourth clock reference value (e.g., about every 800 clock cycles). In response to the adjustment of null packets in the data stream, the clock reference values may be corrected, using the equations described herein, and the corrections to the clock reference values may be distributed to the data packets having a clock reference value (e.g., the data packets occurring every 200 clock cycles in this example) occurring between the null packet events.

For example, using the example timing recited above, a first null packet event (e.g., a null packet insertion or a null packet deletion from the data stream) may occur at approximately 200 clock cycles, and a second null packet event may occur at approximately 1000 clock cycles. The corrections to the clock reference values may be distributed, such that a first clock reference value in a data packet at 200 clock cycles may include a portion of the correction, a second clock reference value in a data packet at 400 clock cycles may include a portion of the correction, a third clock reference value in a data packet at 600 clock cycles may include a portion of the correction, and a fourth clock reference value in a data packet at 800 clock cycles may include a portion of the correction, such that the entirety of the correction may be distributed between multiple clock reference values (e.g., the first, the second, the third, and the fourth clock reference values). By distributing the corrections to the clock reference values across multiple clock reference values in data packets in the data stream, the accuracy of the clock reference values may not breach a threshold, such that the lock of the clock in the receiving device 215 may not be interrupted with the determined clock in the remote device 210.

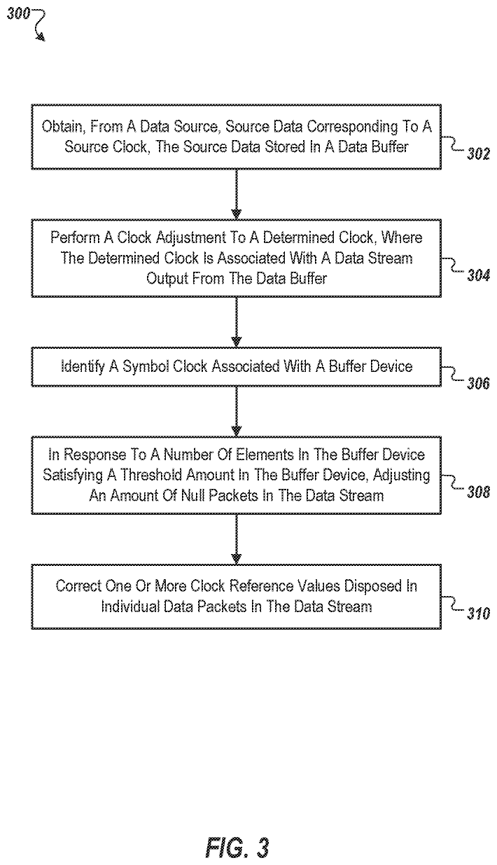

FIG. 3 illustrates an example flow 300 of multiple packets through a network processing system using a hardware distributed architecture, in accordance with at least one embodiment of the present disclosure. The flow 300 may be performed by processing logic that may include hardware (circuitry, dedicated logic, etc.), software (such as is run on a general purpose computer system or a dedicated machine), or a combination of both, which processing logic may be included in any computer system or device, such as the queueing system 120 of FIG. 1. The implementation can also be on Application Specific Integrated Circuit (ASIC) or Programmable Hardware Devices (e.g. FPGA) or Graphics Processing Units (GPU) using dedicated hardware or mix of software and hardware or fully in software.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 302, source data corresponding to a source clock may be obtained from a data source. The source data may be stored in a data buffer. In some embodiments, the data source may be a video server and the source data may be moving picture experts group (MPEG) data. The source data can be from a video core or a CCAP core or a video core integrated with a CCAP core used in DAA in HFC network.

At block 304, a clock adjustment may be performed to a determined clock. The determined clock may be associated with a data stream output from the data buffer. The clock adjustment may be operable to equalize the source clock and the determined clock. The clock adjustment may be determined to be performed in response to an amount of the source data in the data buffer satisfying a buffer data threshold amount.

In some embodiments, the clock adjustment may include monitoring an input buffer rate associated with the source data stored in the data buffer. Alternatively, or additionally, the clock adjustment may include monitoring an output buffer rate associated with the data stream output from the data buffer. Alternatively, or additionally, the clock adjustment may include adjusting the determined clock to cause an amount of source data in the data buffer to converge to a predetermined threshold, where the input buffer rate and the output buffer rate may be equalized.

At block 306, a symbol clock associated with the buffer device may be identified.

At block 308, an amount of null packet in the data stream may be adjusted in response to a number of elements in the buffer device satisfying a threshold amount in the buffer device. In some embodiments, a change to the number of elements in the buffer device may be caused by a difference between the symbol clock and the determined clock.

In some embodiments, one or more of the null packets may be dropped from the data stream in response to the number of elements in the buffer device satisfying an upper threshold amount in the buffer device. Alternatively, or additionally, one or more of the null packets may be inserted into the data stream in response to the number of elements in the buffer device satisfying a lower threshold amount in the buffer device.

Modifications, additions, or omissions may be made to the flow 300 without departing from the scope of the present disclosure. For example, in some instances, one or more clock reference values disposed in individual data packets in the data stream may be corrected, responsive to the adjusting of the null packets in the data stream. In some embodiments, the one or more clock reference values may be corrected by a frequency offset estimation (in part per million) determined using at least the number of elements in the buffer device and characteristics of the null packets in the data stream, over a time interval. The characteristics of the null packets may include a total number of null packets inserted, a total number of null packets dropped, and/or a duration associated with the null packets. Further, the corrected clock reference values may be distributed between at least a data packet in the data stream associated with a first null packet adjustment and a subsequent data packet in the data stream associated with a second null packet adjustment.

Alternatively, or additionally, the one or more clock reference values may be corrected by a delta clock reference value determined using at least characteristics of the null packets in the data stream. The characteristics of the null packets may include a duration associated with the null packets, an average time interval between the null packet adjustments, a first time stamp associated with the clock reference value correction, a second time stamp associated with a null packet adjustment, and/or a time shift associated with a previous null packet adjustment. Further, the corrected clock reference values may be distributed between at least a data packet in the data stream associated with a first null packet adjustment and a subsequent data packet in the data stream associated with a second null packet adjustment.

In another example, the designations of different elements in the manner described is meant to help explain concepts described herein and is not limiting. Further, the flow 300 may include any number of other elements or may be implemented within other systems or contexts than those described.

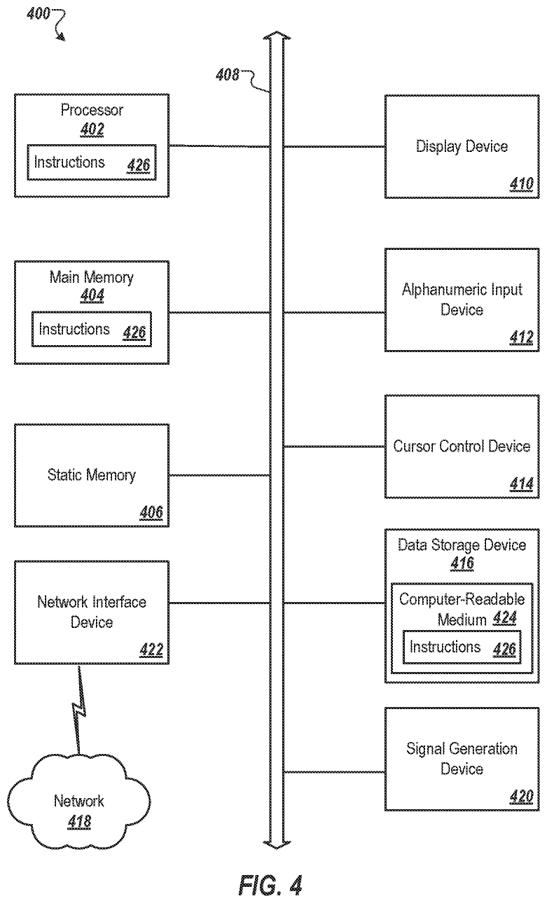

FIG. 4 illustrates a diagrammatic representation of a machine in the example form of a computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one embodiment, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 426 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining, from a data source, source data corresponding to a source clock, the source data stored in a data buffer;
performing a clock adjustment to a determined clock, where the determined clock is associated with a data stream output from the data buffer, and the clock adjustment to equalize the source clock and the determined clock;
identifying a symbol clock associated with a buffer device; and
in response to a number of elements in the buffer device satisfying a threshold amount in the buffer device, adjusting an amount of null packets in the data stream.

2. The method of claim 1, further comprising correcting one or more clock reference values disposed in individual data packets in the data stream, responsive to the adjusting of the null packets in the data stream.

3. The method of claim 2, wherein the one or more clock reference values are corrected by a frequency offset estimation determined using at least the number of elements in the buffer device and characteristics of the null packets in the data stream, over a time interval.

4. The method of claim 3, wherein the characteristics of the null packets comprises a total number of null packets inserted, a total number of null packets dropped, and a duration associated with the null packets.

5. The method of claim 3, wherein the corrected clock reference values are distributed between at least a data packet in the data stream associated with a first null packet adjustment and a subsequent data packet in the data stream associated with a second null packet adjustment.

6. The method of claim 2, wherein the one or more clock reference values are corrected by a delta clock reference value determined using at least characteristics of the null packets in the data stream.

7. The method of claim 6, wherein the characteristics of the null packets comprises a duration associated with the null packets, an average time interval between the null packet adjustments, a first time stamp associated with the clock reference value correction, a second time stamp associated with a null packet adjustment, and a time shift associated with a previous null packet adjustment.

8. The method of claim 6, wherein the corrected clock reference values are distributed between at least a data packet in the data stream associated with a first null packet adjustment and a subsequent data packet in the data stream associated with a second null packet adjustment.

9. The method of claim 1, wherein the clock adjustment is determined to be performed in response to an amount of the source data in the data buffer satisfying a buffer data threshold amount.

10. The method of claim 1, wherein the clock adjustment further comprises:
monitoring an input buffer rate associated with the source data stored in the data buffer;
monitoring an output buffer rate associated with the data stream output from the data buffer; and
adjusting the determined clock to cause an amount of source data in the data buffer to converge to a predetermined threshold, where the input buffer rate and the output buffer rate are equalized.

11. The method of claim 1, wherein a change to the number of elements in the buffer device is caused by a difference between the symbol clock and the determined clock.

12. The method of claim 1, wherein the data source is a video server, a video core, or a CCAP core with video broadcast functionality integrated in a distributed access architecture (DAA) in Hybrid-Fiber Cable (HFC) network and the source data is moving picture experts group (MPEG) data.

13. The method of claim 1, wherein in response to the number of elements in the buffer device satisfying an upper threshold amount in the buffer device, dropping one or more of the null packets from the data stream.

14. The method of claim 1, wherein in response to the number of elements in the buffer device satisfying a lower threshold amount in the buffer device, inserting one or more of the null packets into the data stream.

15. A device comprising:
a data buffer to store source data from a data source, the source data corresponding to a source clock;
a clock adjustment device to perform a clock adjustment to a determined clock to equalize the source clock and the determined clock; and
a buffer device to adjust an amount of null packets in a data stream output from the data buffer, wherein the buffer device adjusts the null packets in response to a number of elements in the buffer device satisfying a threshold amount in the buffer device.

16. The device of claim 15, further comprising a reference correction device to correct one or more clock reference values disposed in individual data packets in the data stream, responsive to the adjusting of the null packets in the data stream.

17. The device of claim 16, wherein the one or more clock reference values are corrected by a frequency offset estimation determined using at least the number of elements in the buffer device and characteristics of the null packets in the data stream, over a time interval.

18. The device of claim 17, wherein the corrected clock reference values are distributed between at least a data packet in the data stream associated with a first null packet adjustment and a subsequent data packet in the data stream associated with a second null packet adjustment.

19. The device of claim 15, wherein the data source is a video server and the source data is moving picture experts group (MPEG) data.

20. The device of claim 15, wherein:
in response to the number of elements in the buffer device satisfying an upper threshold amount in the buffer device, dropping one or more of the null packets from the data stream; and
in response to the number of elements in the buffer device satisfying a lower threshold amount in the buffer device, inserting one or more of the null packets into the data stream.
